(19) United States
(12) Patent Application Publication
(10) Pub. No.: US 2006/0277431 A1
(43) Pub. Date: Dec. 7, 2006

(54) Real time auto-backup memory system

(76) Inventor: Ta-Lang Hsu, Taipei Hsien (TW)

Correspondence Address: Ta-Lang Hsu, 235 Chung-Ho, Box 8-24, Taipei, TW

(21) Appl. No.: 11/183,280

(22) Filed: Jul. 18, 2005

(30) Foreign Application Priority Data
Jun. 6, 2005 (TW) 094200245

(51) Int. Cl. G06F 11/00

(52) U.S. Cl. 714/6

(57) ABSTRACT

A real time auto-backup memory system comprises a CPU; a system transmission interface connected to the CPU; a bridge control unit connected to the system transmission interface; a system memory disk connecting port connected to the bridge control unit; a backup memory disk connecting port connected to the bridge control unit; a system memory disk connected to the system memory disk connecting port; a backup memory disk connected to the backup memory disk connecting port. The bridge control unit serves for detecting data difference between a system memory disk and a backup memory disk. As the central processing unit is started, the bridge control unit will direct record works to the system memory disk. The bridge control unit controls the system memory disk to backup data in time. The data in the system memory disk is recorded to the backup memory disk, while the CPU does its work without interference.

### FIELD OF THE INVENTION

The present invention relates to a real time auto-backup memory system, wherein the CPU records to data to a system memory disk and then the data in the system memory disk is recorded to a backup memory disk under the control of a bridge control unit through the technology of mirror or rebuilding. The CPU still does its work without any interference.

### BACKGROUND OF THE INVENTION

In the prior art, the data in a computer device is backup manually, That is, another memory device, such as a compact disk, a floppy disk, or a hard disk is inserted into a slot of a computer. Then an operator records the data from the hard disk to another memory disk. The operation is tedious and not efficiently. Thereby it is impossible that the operator always records the data in time so that it is possible that some data is lost as the original hard disk is destroyed and there is a time period that the backup work cannot be done.

To improve this defect, in one improvement, an auto-back system is disclosed, in that the central processing unit (CPU) of the computer records data to the hard disks at the same time so that the computer device must be prepared with two different hard disks. It is expensive and not time efficient since a longer time is necessary for the CPU to backup two memories at the same time.

### SUMMARY OF THE INVENTION

Accordingly, the primary object of the present invention is to provide a real time auto-backup memory system, wherein the CPU records to data to a system memory disk and then the data in the system memory disk is recorded to a backup memory disk under the control of the bridge control unit through the technology of mirror or rebuilding. The CPU still does its work without any interference.

To achieve above objects, the present invention provides a real time auto-backup memory system. The real time auto-backup memory system comprises a central processing unit; a system transmission interface connected to the central processing unit; a bridge control unit connected to the system transmission interface; a system memory disk connecting port connected to the bridge control unit; a backup memory disk connecting port connected to the bridge control unit; a system memory disk connected to the system memory disk connecting port; a backup memory disk connected to the backup memory disk connecting port. The bridge control unit serves for detecting data difference between a system memory disk and a backup memory disk. As the central processing unit is started, the bridge control unit will direct record works to the system memory disk. The bridge control unit controls the system memory disk to backup data in time by the mirror technology; that is the data in the system memory disk is recorded to the backup memory disk in time, while the CPU still does its work without interference.

The various objects and advantages of the present invention will be more readily understood from the following detailed description when read in conjunction with the appended drawing.

### BRIEF DESCRIPTION OF THE DRAWINGS

FIG. 1 is a system block diagram of the present invention.

FIG. 2 is a flow diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

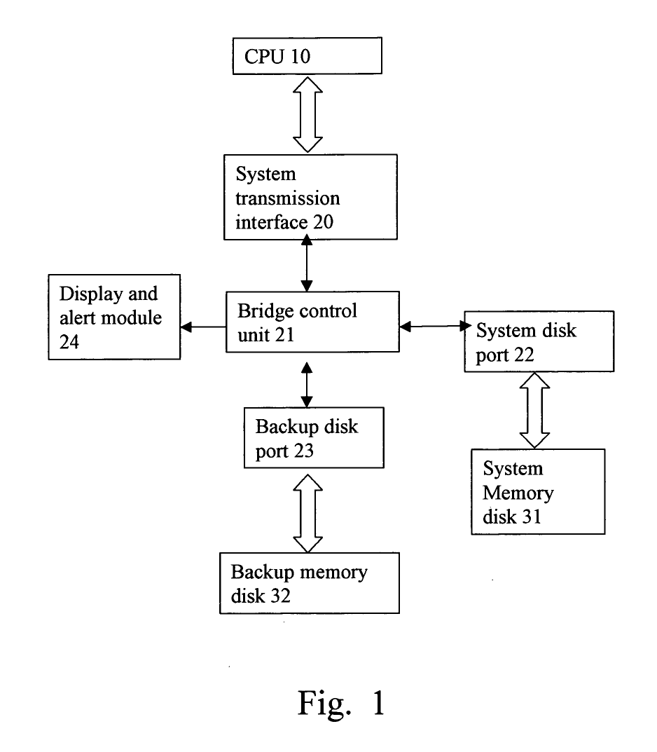

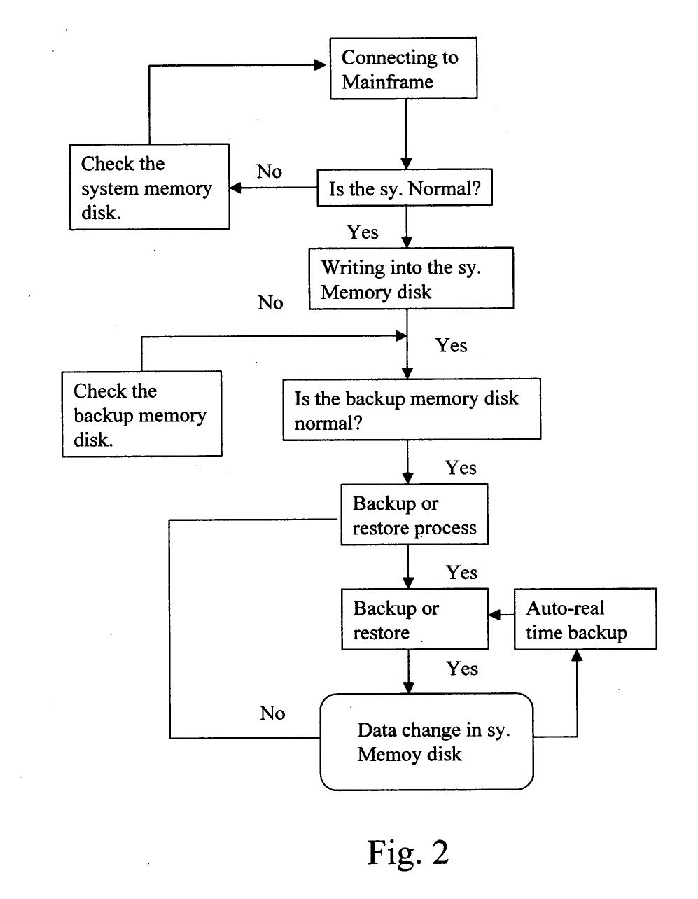

With reference to FIGS. 1 and 2, the present invention is illustrated. The present invention includes the following elements.

A central processing unit 10 is installed on a motherboard (not shown).

A system transmission interface 20 is connected to the central processing unit 10, such as an IDE interface, a SATA interface or a SCSI interface.

A bridge control unit 21 is connected to the system transmission interface 20 for detecting data difference between the system memory disk 31 and the backup memory disk 32. As the central processing unit 10 is started, the bridge control unit 21 will direct record works to the system memory disk 31. The bridge control unit 21 controls the backup memory disk 32 to backup data in time by the mirror or rebuilding technology; that is, the bridge control unit 21 directs the data different between the system memory disk 31 and backup memory disk 32 to the backup memory disk 32 in time, but the work of the CPU is not interfered; and the backup message is feedback to the bridge control unit 21. If the system memory disk 31 has faults, the bridge control unit 21 will switch to the backup memory disk 32 for recoding data.

A system memory disk connecting port 22 is connected to the bridge control unit 21.

A backup memory disk connecting port 23 is connected to the bridge control unit 21.

The system memory disk 31 is connected to the system memory disk connecting port 22.

The backup memory disk 32 is connected to the backup memory disk connecting port 23.

A display and alert module 24 is connected to the bridge control unit 21 for displaying the abnormality of the system memory disk 31 or the backup memory disk 32 and requesting the user to repair the system memory disk 31 or the backup memory disk 32. The display and alert module 24 alerts the user by light or sounds.

In the present invention, the system memory disk 31 and backup memory disk 32 may be the different sections in one hard disk. Thereby the system memory disk 31 can record the data in the backup memory disk 32 and the backup memory disk 32 can record the data in the system memory disk 31.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A real time auto-backup memory system comprising:
a central processing unit;
a system transmission interface connected to the central processing unit;
a bridge control unit connected to the system transmission interface;
a system memory disk connecting port connected to the bridge control unit;
a backup memory disk connecting port connected to the bridge control unit;
a system memory disk connected to the system memory disk connecting port; and
a backup memory disk connected to the backup memory disk connecting port;
wherein the bridge control unit serves for detecting data difference between a system memory disk and a backup memory disk; as the central processing unit is started, the bridge control unit will direct record works to the system memory disk; the bridge control unit controls the system memory disk to backup data in time by the mirror technology; that is the data in the system memory disk is recorded to the backup memory disk in time, while the CPU still does its work without interference.

2. The real time auto-backup memory system as claimed in claim 1, wherein the system memory disk and backup memory disk are different sections in one hard disk; and the system memory disk is capable of recording data in the backup memory disk and the backup memory disk is capable of recording data in the system memory disk.

3. The real time auto-backup memory system as claimed in claim 1, wherein the backup message is feedback to the bridge control unit; if the system memory disk has faults, the bridge control unit will switch to the backup memory disk for recoding data.

4. The real time auto-backup memory system as claimed in claim 1, wherein a display and alert module is connected to the bridge control unit for displaying the abnormality of the system memory disk or the backup memory disk and requesting the user to repair the system memory disk or the backup memory disk; and the display and alert module alerts the user by light or sounds.

5. The real time auto-backup memory system as claimed in claim 1, wherein the system transmission interface is selected from one of IDE interfaces, SATA interfaces and SCSI interfaces.

6. The real time auto-backup memory system as claimed in claim 1, wherein the bridge control unit records data from system memory disk to backup memory disk by mirror or rebuilding technology.
